(19) United States
(12) Patent Application Publication
(10) Pub. No.: US 2024/0131720 A1
(43) Pub. Date: Apr. 25, 2024

(54) ROBOT-CONTROLLED MODULAR ROTARY TABLE ASSEMBLY

(71) Applicant: Kinetic Technologies, L.L.C., Algona, IA (US)

(72) Inventors: Mark Barglof, Burt, IA (US); Kyle Post, Titonka, IA (US); Ted Pappas, Plymouth, IA (US)

(21) Appl. No.: 18/490,206

(22) Filed: Oct. 18, 2023

Related U.S. Application Data
(60) Provisional application No. 63/417,581, filed on Oct. 19, 2022.
(60) Provisional application No. 63/443,245, filed on Feb. 3, 2023.
(60) Provisional application No. 63/517,789, filed on Aug. 4, 2023.

(51) Int. Cl. B25J 11/00; B23K 37/04

(52) U.S. Cl. CPC B25J 11/0055; B23K 37/04

(57) ABSTRACT

A rotary table assembly for rotatably supporting a workpiece can include a table having a table top surface positioned in a first plane, where the table has an axis of rotation. The rotary table assembly can also include a gearbox fixedly connected to the table for precisely rotating the table, and a support frame for supporting the table. The support frame has a support surface spaced apart from the axis of rotation of the table at a first precise, predetermined distance. The support surface is positioned in a second plane at least substantially parallel to the first plane and spaced apart from the first plane at a second precise, predetermined distance. A robotic device can be interchangeably couplable with the rotary table assembly and another rotary table assembly, where the robotic device can perform operations based upon the first precise, predetermined distance and the second, precise predetermined distance.

### RELATED APPLICATIONS

The present application claims the benefit under 35 U.S.C. § 119(e) of U.S. Provisional Application Ser. No. 63/417,581, filed Oct. 19, 2022, and titled “ROBOT-CONTROLLED MODULAR ROTARY TABLE ASSEMBLY;” U.S. Provisional Application Ser. No. 63/443,245, filed Feb. 3, 2023, and titled “ROBOT-CONTROLLED MODULAR ROTARY TABLE ASSEMBLY;” and U.S. Provisional Application Ser. No. 63/517,789, filed Aug. 4, 2023, and titled “ROBOT-CONTROLLED MODULAR ROTARY TABLE ASSEMBLY AND MODULAR ROTARY HEADSTOCK POSITIONER ASSEMBLY;” which are herein incorporated by reference in their entireties.

### BACKGROUND

Robot welding is the operation of automating a welding process with the use of mechanized programmable tools (e.g., robots) configured to handle and weld a working piece. Robot welding is used in high production applications and has advantages over traditional welding including increased productivity, decreased risk of injury, and consistent quality.

### DRAWINGS

The Detailed Description is described with reference to the accompanying figures. The use of the same reference numbers in different instances in the description and the figures may indicate similar or identical items.

FIG. 1 is an isometric view illustrating a rotary table assembly including a table, a gearbox, and a support frame, where the rotary table assembly is shown with an attached robotic device in accordance with example embodiments of the present disclosure.

FIG. 2 is a partial exploded isometric view of the rotary table assembly illustrated in FIG. 1.

FIG. 3 is a side elevation view of the rotary table assembly and robotic device illustrated in FIG. 1.

FIG. 4 is a top plan view illustrating a modular table including a center piece and multiple interlocking table top segments in accordance with example embodiments of the present disclosure.

FIG. 5 is a top plan view of the center piece illustrated in FIG. 4.

FIG. 6 is a top plan view of a table top segment illustrated in FIG. 4.

FIG. 7 is an isometric view illustrating interchangeable robotic table system including multiple rotary table assemblies and robotic devices, such as the rotary table assembly and robotic device illustrated in FIG. 1, in accordance with example embodiments of the present disclosure.

FIG. 8 is an isometric view illustrating a longitudinal chassis for a rotary table assembly, such as the rotary table assembly illustrated in FIG. 1, where the longitudinal chassis includes an extension plate in accordance with example embodiments of the present disclosure.

FIG. 9 is a diagrammatic illustration of an interchangeable robotic table system in accordance with example embodiments of the present disclosure.

FIG. 10 is an exploded isometric view illustrating a rotary table assembly including a table, a gearbox, and a support frame in accordance with example embodiments of the present disclosure.

FIG. 11 is a top plan view illustrating a modular table including a center piece and multiple interlocking table top segments for a rotary table assembly, such as the rotary table assembly illustrated in FIG. 10, in accordance with example embodiments of the present disclosure.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

### Overview

Robotic devices such as stationary robot arms are used in a wide variety of manufacturing applications such as but not limited to welding, painting, assembly and disassembly, packaging, inspecting, and testing. These robotic devices may be automated, programmable, and capable of moving on three or more axes depending on their specific applications. Different types of stationary robots include cartesian robots, cylindrical robots, spherical robots, Selective Compliance Assembly Robot Arms (SCARAs), articulated robots, among others.

Cobots, or collaborative robots, are robotic devices designed for direct interaction with humans and other cobots. Cobots may interact with humans and other cobots at different levels. For example, coexisting cobots work alongside humans without barriers or fences between their respective separate workspaces. Other cobots collaborate with humans sequentially: they work in a shared workspace, but they do not work on a workpiece at the same time (e.g., their motions are sequential).

Typical stationary robotic devices are restricted by their physical reach in a workspace. When the stationary robotic devices are mounted to a table or a station, the workspace is limited, and the robotic devices have a finite access to reach the workpiece at various angles. Additionally, there is an added cost of having multiple robot stations separate from the human worker stations, financially and space-wise.

As described herein, a modular rotary table assembly is used with a robotic device such as a cobot. The rotary table assembly includes a table, a support frame, and a gearbox, where these components are disposed at a precise and predetermined position and/or distance from one another. This precise and predetermined position allows the rotary table assembly to disengage and replace a first robotic device for a second robotic device having the same tolerances with the same accuracy used in the first robotic device.

Moreover, the table of the rotary table assembly includes a table top surface that is rotatable and driven by the gearbox. The table top surface includes a center piece surrounded by multiple interlocking table top segments. The table top segments are supported by multiple support arms fixedly connected to the center piece. The table top segments surrounding the center piece may be interchanged for table top segments forming a table top surface of a smaller or a larger diameter depending on the workpiece to be processed.

The rotary table assembly increases the physical reach of the robotic device stationed in a support surface of the support frame. Furthermore, the rotary table assembly increases the utilization of the robotic device by allowing an operator to access one side of the table opposite to the support surface on which the robotic device is operating. The rotary table assembly conserves workstation space and reduces the investment cost of having multiple robot stations.

### Detailed Description of Example Embodiments

For the purposes of promoting an understanding of the principles of the subject matter, reference will now be made to the embodiments illustrated in the drawings and specific language will be used to describe the same. It will nevertheless be understood that no limitation of the scope of the subject matter is thereby intended. Any alterations and further modifications in the described embodiments, and any further applications of the principles of the subject matter as described herein are contemplated as would normally occur to one skilled in the art to which the subject matter relates.

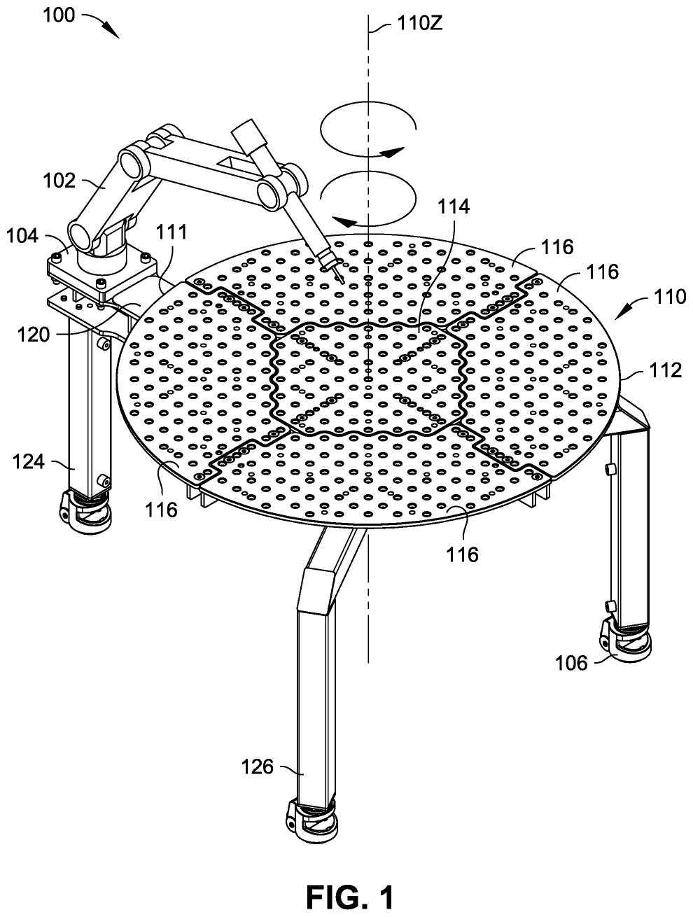

Referring generally to FIGS. 1 through 11, modular rotary table assemblies 100 are described. A rotary table assembly 100 removably attaches with a robotic device 102 having a base 104. The rotary table assembly 100 supports a workpiece (not shown) to be rotated in an industrial process such as but not limited to welding, painting, grinding, gluing, sanding, assembly, disassembly, inspection, and testing. The rotary table assembly 100 includes a table 110, a support frame 120, and a gearbox 130. The table 110 of the rotary table assembly 100 includes a table top surface 112 positioned in a first plane 110X. The table top surface 112 is configured to rotate around an axis of rotation 110Z, where the axis of rotation 110Z is generally perpendicular to the first plane 110X.

In some embodiments, the rotary table assembly 100 can be used for pick and place operations, where parts are moved from one place to another on the table 110. For example, the rotary table assembly 100 can be used to sort fasteners. As described herein, the rotary table assembly 100 can be used with robotic devices 102 equipped with computer vision functionality, e.g., where a computer processor derives information from electronic images collected by a robotic vision system and operates the table 110 and/or performs operations on items on the table based upon identifications made by the computer vision system. In some embodiments, the rotary table assembly 100 and one or more robotic devices 102 can be used for the application of material(s) to items on the table 110. For instance, sealant can be applied by a robotic device 102 to one or more items on the table 110. In another example, fasteners can be installed in one or more items on the table 110 (e.g., where the fasteners are selected and placed using a computer vision system).

As shown in FIG. 1, the support frame 120 supports the table 110. The support frame 120 includes a support surface 122, a first support leg 124, second support legs 126, and a longitudinal chassis 128. The support surface 122 is spaced apart from the axis of rotation 110Z by the longitudinal chassis 128 and is positioned above the first support leg 124. The support surface 122 includes a first row of mount holes 121 and a second row of mount holes 123, where the first and second rows of mount holes 121 and 123 are configured to receive fasteners for the base 104 of the robotic device 102. In other embodiments, the support surface 122 may have less than or more than a first and a second row of mount holes 121 and 123. The mount holes of the support surface 122 may be aligned generally parallel with respect to one another and/or may be aligned in a differently shaped pattern (e.g., generally diagonally with respect to one another).

In the embodiment shown in FIG. 1, the support frame 120 includes two (2) second support legs 126 positioned opposite to the first support leg 124. The second support legs 126 extend substantially radially from the support frame 120 in reference to the axis of rotation 110Z. In other embodiments (not shown) the support frame 120 may include more than two (2) second support legs 126. The second support legs 126 may be positioned tangentially in reference with the table 110 or perpendicular to the first support leg 124. The first support leg 124 and the second support legs 126 may include roller features 106 located at the ends of each of the first support leg 124 and the second support legs 126, opposite to the table 110. The roller features 106 may be at least one of a caster wheel, a glider, among others and include leveling mounts, brakes, etc.

The support surface 122 is disposed at a first precise predetermined distance X1 from the axis of rotation 110Z of the table 110. In embodiments, the first precise predetermined distance X1 may be defined as a longitudinal distance between the axis of rotation 110Z and the first row of mount holes 121. Likewise, the first precise predetermined distance X1 may be defined as the longitudinal distance between the axis of rotation 110Z and a center of the support surface 122 between the first row of holes 121 and the second row of holes 123.

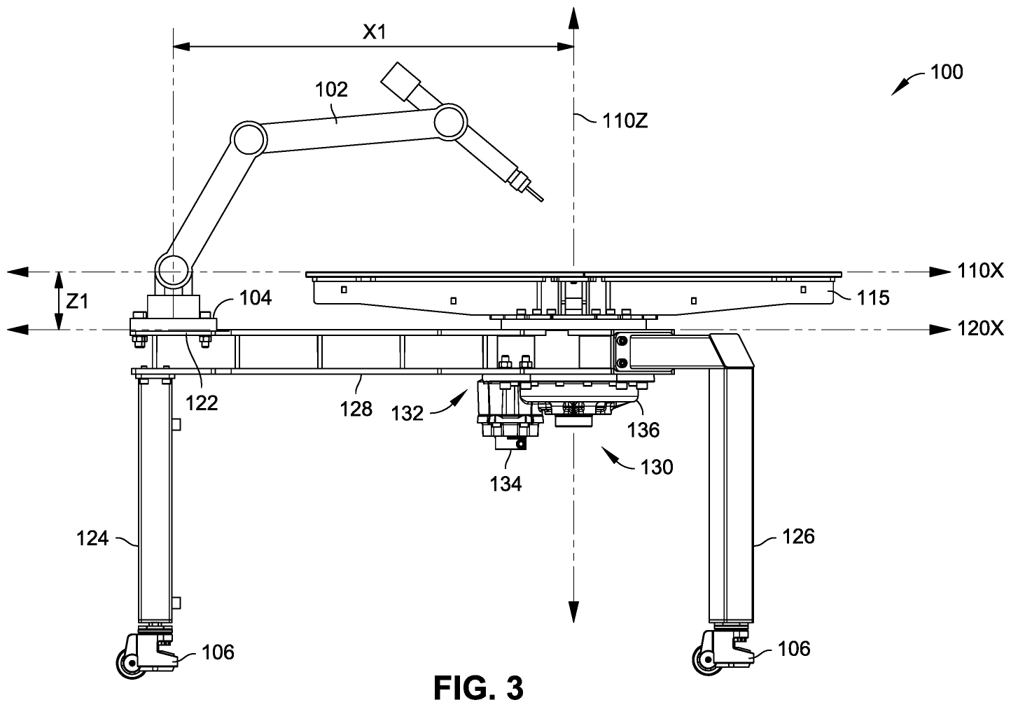

The support surface 122 is disposed at a second plane 120X. The second plane 120X may be placed apart from the first plane 110X at a second precise predetermined distance Z1 and is at least substantially parallel to the first plane 110X, as shown in FIG. 3. In the example embodiment shown, the second plane 120X is positioned below the first plane 110X. In other embodiments (not shown) the second plane 120X may be positioned above the first plane 110X or may be coplanar with the first plane 110X. For example, when the first plane 110X and the second plane 120X are coplanar, the second precise predetermined distance Z1 may be zero.

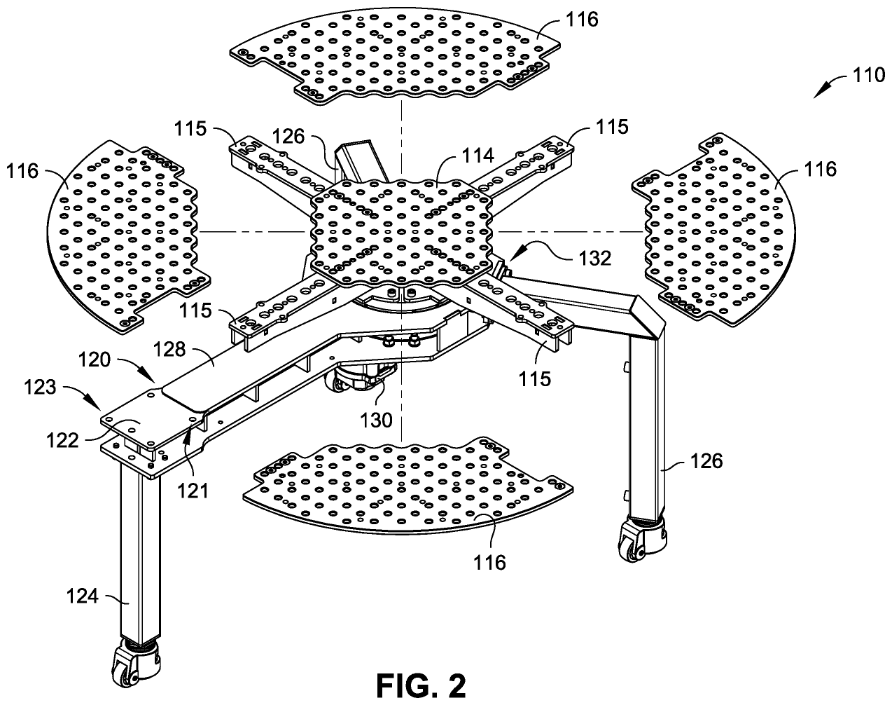

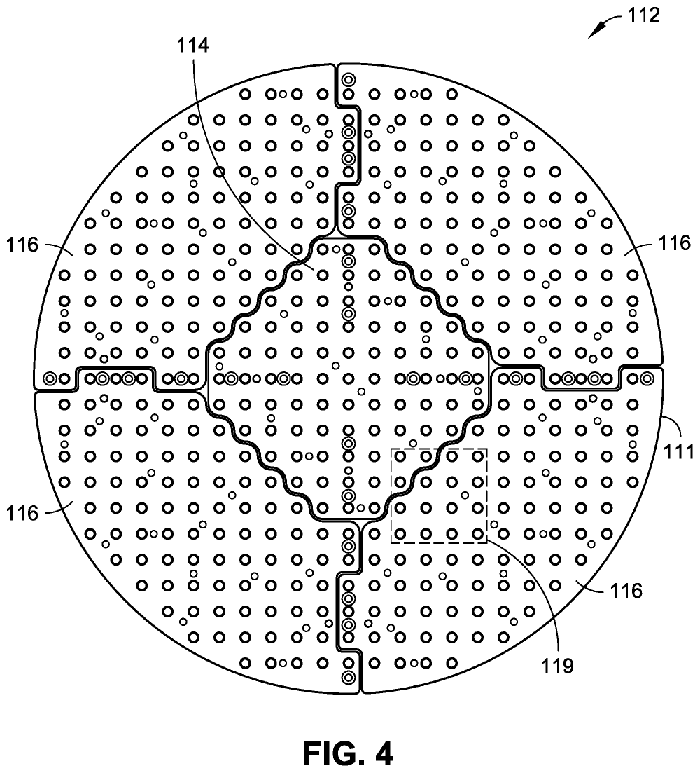

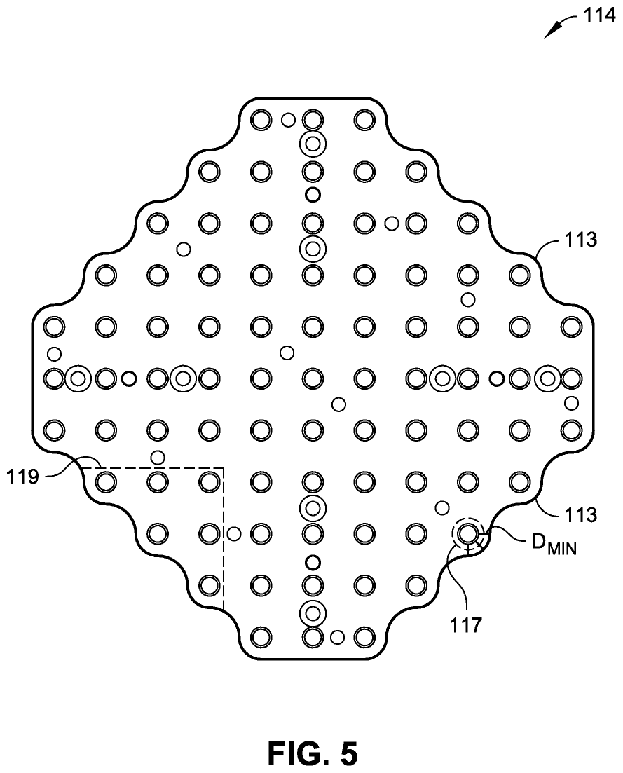

With reference to FIGS. 2, 4 through 6, 10, and 11, table 110 can be a modular table configured to be fitted together in different sections. The table top surface 112 of the table 110 includes a center piece 114, supporting arms 115, and table top segments 116. The center piece 114 has exterior sides 113 (FIG. 5) and a center aligned with the axis of rotation 110Z. In example embodiments, such as those described with reference to FIGS. 4, 5, and 11, the center piece 114 is generally square, with exterior sides 113 that are generally diagonally angled.

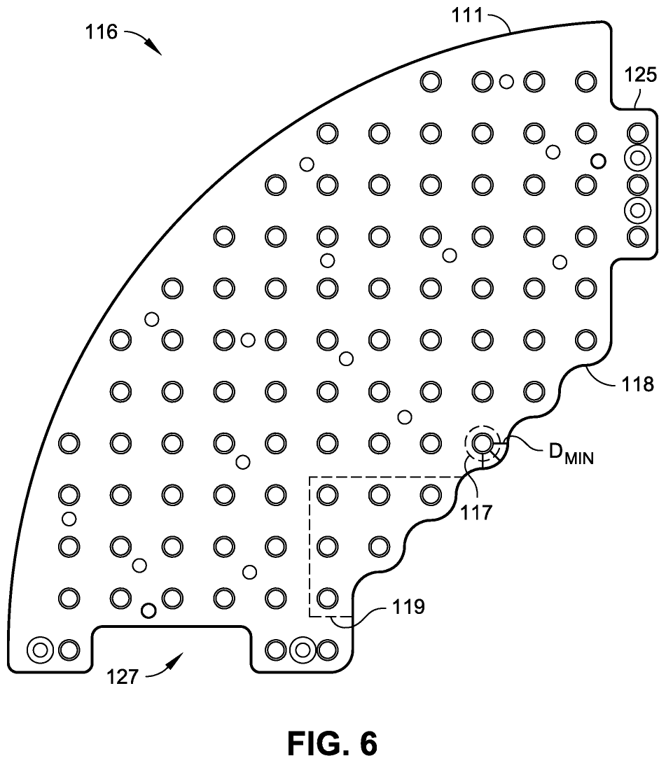

The support arms 115 are fixedly connected to the center piece 114 and extend outwardly from the center piece 114. The center piece 114 is surrounded by the table top segments 116, which are supported by the support arms 115. The table top segments 116 have interior sides 118 (FIG. 6) configured to interlock with one another and with the center piece 114. The table top segments 116 form a generally circular table top surface 112 when the table top segments 116 and the center piece 114 are interlocked together. The table top segments form a generally circular shape having an exterior edge 111.

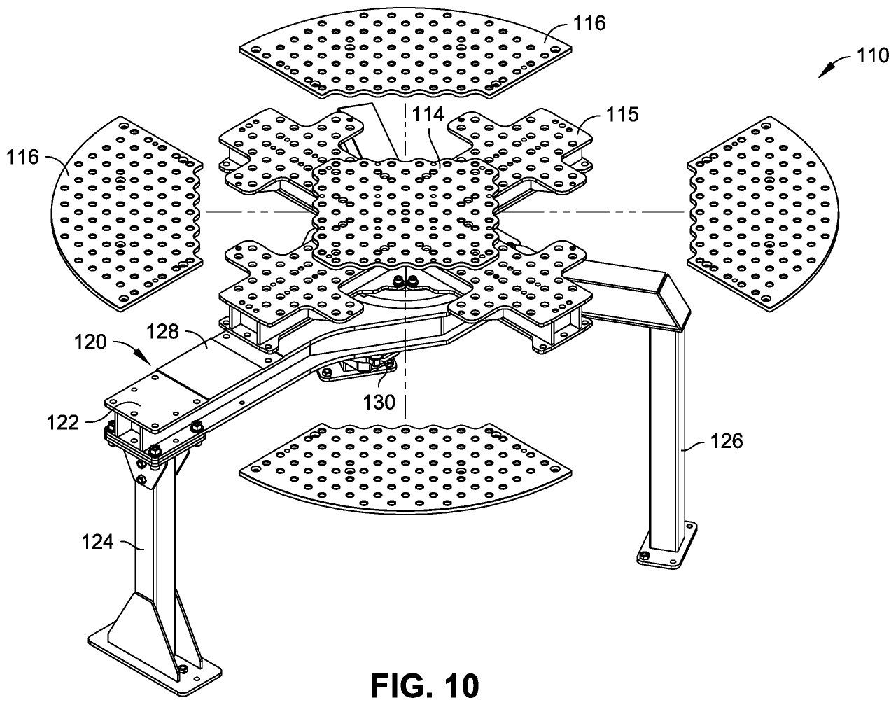

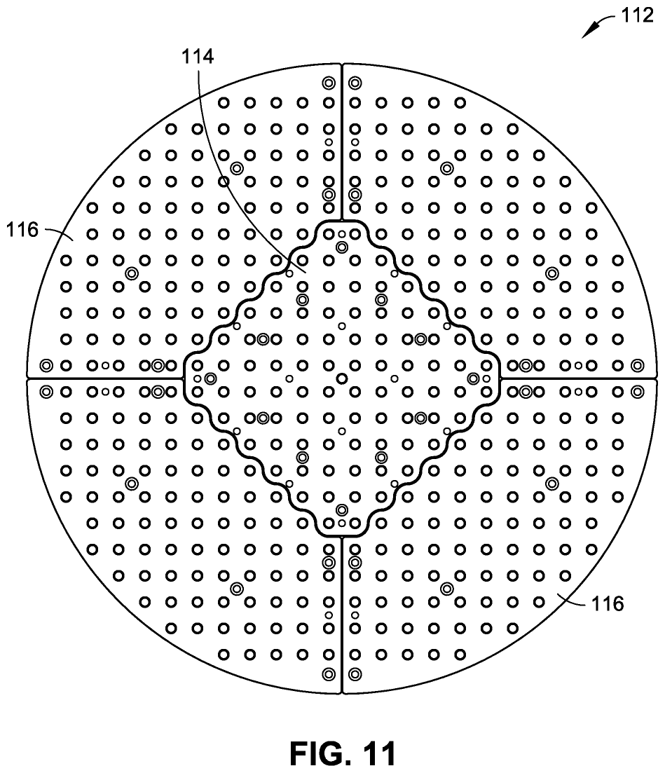

In some embodiments, each one of the table top segments 116 includes at least one tab feature 125 and at least one relief feature 127. The at least one tab feature 125 of each of the table tops segments 116 is configured to engage and interlock with an adjacent relief feature of another one of the table top segments 116. In the embodiment shown in FIGS. 1 through 4, the table 110 includes four (4) table top segments 116. In other embodiments (not shown) the table top segments 116 may have a different number of table top segments 116, and may be at least two (2) table top segments 116. As shown in FIGS. 2 and 4, in some embodiments, a support arm 115 may include a single row of apertures for receiving fasteners to secure the table top segments 116 to the support arms, e.g., where the tab features 125 and relief features 127 interleave with one another along the single row of fasteners. In the embodiment shown in FIGS. 10 and 11, the table top segments 116 do not include tab or relief features. For example, each table top segment 116 has a row of apertures along opposing sides, and the corresponding support arms 115 have two (or more) rows of apertures for receiving fasteners to secure the table top segments 116 adjacent to one another.

The table top segments 116 of the table 100 may be configured to be replaced based on the size of the workpiece on the table top surface 112. In an embodiment (not shown) more table top segments 116 are added around the center piece 114 to increase a diameter of the table top surface 112. A change in diameter of the table top surface 112 may not affect the first precise predetermined distance between the axis of rotation 110Z and the support surface 122.

A dimensional tolerance between the exterior edge 111 of the table top surface 112 and the support surface 122 is maintained. The dimensional tolerance is the total amount that a specific dimension is allowed to vary. In embodiments, the dimensional tolerance of the rotation of the table 110 is at least five thousandths of an inch (0.005 in.). In other embodiments, the dimensional tolerance of rotation of the table 100 may be lower or higher.

In embodiments, at least one table top segment 116 and the center piece 114 together define a hole pattern 119 composed of holes 117. In the embodiment shown, adjacent interior sides 118 of the at least one table top segment 116 and the center piece 114 extend diagonally within the hole pattern 119 at right angles to one another to provide at least a minimum distance D MIN between each hole 117 of the hole pattern 119 in the exterior sides 113 and the interior sides 118.

Referring to FIGS. 4 and 11, the four (4) table top segments 116 define the hole pattern 119 when placed and secured around the center piece 114. The hole pattern 119 is configured to help secure the workpiece to the rotary table assembly 100 for processing. The holes 117 may be used along with accessories (not shown) such as jigs, stops, and clamps, among others. In some embodiments, the hole pattern 119 extends to the at least one tab feature 125 and the at least one relief feature 127 of each of the table top segments 116. As previously described, the rotary table assembly 100 can be used with robotic devices 102 equipped with computer vision functionality. It is noted that the hole pattern 119, holes 117, interfaces/edges between adjacent table top segments 116, interfaces/edges between the table top segments 116 and the center piece 114, and so forth may be used by a robotic vision system as datums or reference features to locate the table top surface 112 in space with respect to a robotic device 102 and/or with respect to equipment mounted to the robotic device 102 and/or the table 110. The precise and predetermined position of table components of rotary table assemblies 100, e.g., where the same tolerances and accuracy are present across multiple table assemblies, allow for repeatable operations on different table assemblies.

As shown in FIG. 2, the gearbox 130 is fixedly connected to the table 110 for precisely rotating the table top surface 112. The support frame 120 defines a gearbox mount 132 that receives the gearbox 130 and engages with the center piece 114 and the support arms 115. The gearbox 130 may include a motor 134, a case 136 and a set of gears (not shown). The motor 134 may be a servo motor, a linear motor, a spindle motor, or a stepper motor, among others. The motor 134 includes an output shaft (not shown) in direct contact with the set of gears. The output shaft of the motor may be connected in a straight configuration or a right angle configuration to the set of gears. In embodiments, the set of gears is configured to work as a reduction gear that decelerates the rotation of the motor 134 and transmits rotational torque to the table 110. In other embodiments, the gearbox 130 may include a pulley (not shown) connected to the reduction gear for a pulley input configuration.

In manufacturing applications, angular movement may be measured in minutes and/or seconds of an arc for accuracy. One minute of an arc, also referred to as arcmin or minute arc, is equal to one-sixtieth ( 1/60) of a degree. In the rotary table assembly 100, the robotic device 102 is configured to control the gearbox 130 and thereby a speed and an angular rotation of the table 100 with respect to the support frame 120. The robotic device may rotate the table top surface 112 within accurate arcmin of rotation, allowing the workpiece to be rotated at a predetermined speed to a desired angle. The angular rotation and speed of the table 100 may be determined by the desired operation of the robotic device 102 and the shape and dimensions of the workpiece.

The support arms 115 are removably attached to the support frame 120 and are removably attached to the center piece 114 and the table top segments 116. The support arms 115 are configured to self-align through the alignment of holes 117 defined on a top surface of the support arms 115 and the holes 117 of the hole pattern 119 of the table top segments 116.

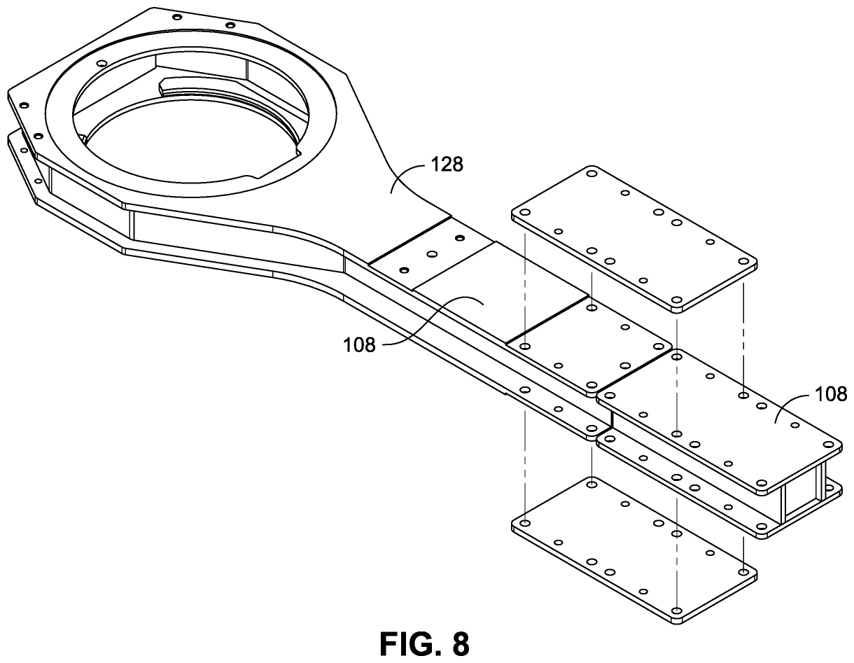

As shown in FIG. 8, the rotary table assembly 100 may further include an extension plate 108 for extending the longitudinal chassis 128. The extension plate 108 may be placed in the longitudinal chassis 128 to extend the longitudinal distance between the axis of rotation 110Z and the support surface 122 to a third precise determined distance X3. The extension plate 108 may be placed on the support frame 120 if the table top segments 116 are interchanged with different table top segments (not shown) that, when interlocked with the center piece 114, form a table top surface 112 having a radius larger than the first precise determined distance X1.

In example embodiments, the extension plate 108 may include attachment plates above and below the connecting point between the extension plate 108 and the longitudinal chassis 128. In some embodiments, the extension plate 108 may be included at the end of the longitudinal chassis 128, and the position of the support surface 122 may move from the end of the longitudinal chassis 128 to the end of the extension plate 108 opposite to the table 110, as shown in FIG. 8. In other embodiments (not shown), the longitudinal chassis 128 and the extension plate 108 may define a gap that separates both components, where the gap is defined between the attachment plates. In yet another embodiment, the extension plate may be placed between the support surface 122 and the longitudinal chassis 128, where the extension plate acts as an extension leaf. In this embodiment, the attachment plates may extend over the entirety of the length of the extension plate 108 and attach at the longitudinal chassis and the support surface 122 or be composed of two (2) pairs of attachment plates. In this embodiment, one of the pairs of attachment plates may connect the support surface 122 with the extension plate 108 and the other one of the pairs of attachment plates may connect the extension plate 108 with the longitudinal chassis 128.

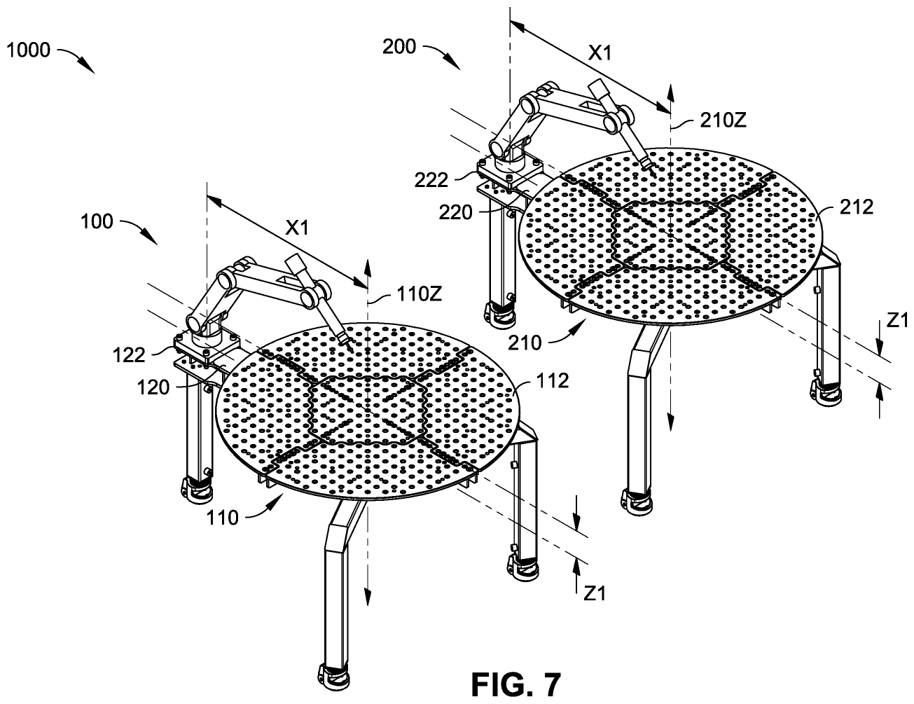

With reference to FIG. 7, in embodiments, two or more rotary table assemblies 100 may be used together to implement an interchangeable robotic table system 1000. The interchangeable robotic table system 1000 may include a robotic device 102, first rotary table assembly 100 and at least a second rotary table assembly 200. Both the first and second rotary table assemblies 100 and 200 are configured to rotatably support a respective workpiece (not shown) and are controlled by the robotic device 102.

A first table 110 of the first rotary table assembly 100 includes a first table top surface 112 positioned in a first plane 110X. The first table top surface 112 rotates around a first axis of rotation 110Z. The first rotary assembly 100 also includes a first support frame 120 for supporting the first table. The first support frame 120 may include a first support surface 122 spaced apart from the first axis of rotation 110Z of the first table 110 at a first precise, predetermined distance X1. The first support surface 122 is positioned in a second plane 120X that is at least substantially parallel to the first plane 110X and is spaced apart from the first plane 110X at a second precise, predetermined distance Z1.

The second rotary table assembly 200 includes a second table 210 that has a second table top surface 212 positioned in a third plane 210X. The second table top surface 212 rotates around a second axis of rotation 210Z. The second rotary assembly 100 also includes a second support frame 220 for supporting the second table 210. The second support frame includes a second support surface 222 spaced apart from the second axis of rotation 210Z of the second table 210 at the first precise, predetermined distance X1. The second support surface is positioned in a fourth plane 220X that is at least substantially parallel to the third plane 210X and is spaced apart from the third plane 210X at the second precise, predetermined distance Z1.

The robotic device 102 may be interchangeably couplable with the first rotary table assembly 100 and the at least second rotary table assembly 200. The robotic device 102 may be removably coupled to the first support surface 122 and with the second support surface 222. The robotic device 102 may be swapped between the first rotary table assembly 100 and the second rotary table assembly 200.

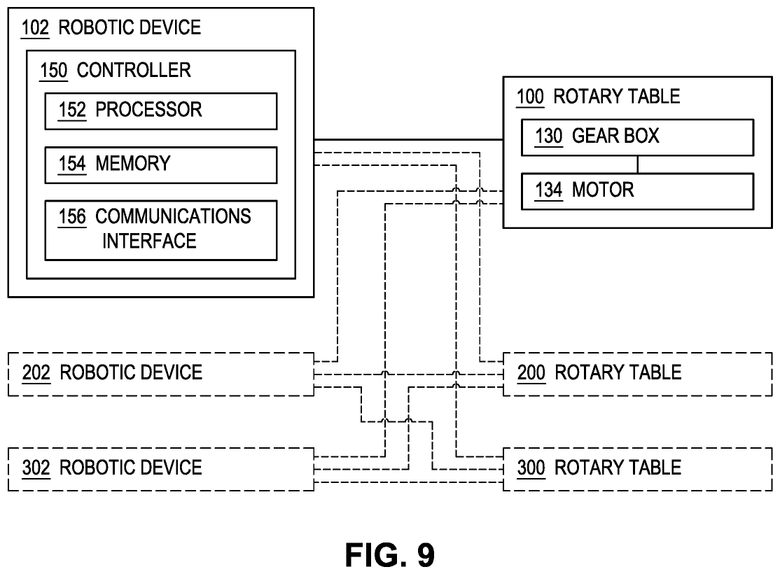

Referring to FIG. 9, the robotic device 102, including some or all of its components, can operate under computer control. For example, a processor can be included with or in the robotic device 102 to control the components and functions of the first rotary table assembly 100 and the at least second rotary table assembly 200 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the robotic device 102 100. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

The robotic device 102 can be coupled with a controller 150 for controlling the operations performed by the robotic device 102 including but not limited to the control of the rotary table assembly 100. The controller 150 can include a processor 152, a memory 154, and a communications interface 156. The processor 152 provides processing functionality for the controller 150 and can include any number of processors, micro-controllers, or other processing systems, and resident or external memory for storing data and other information accessed or generated by the controller 150. The processor 152 can execute one or more software programs that implement techniques described herein. The processor 152 is not limited by the materials from which it is formed or the processing mechanisms employed therein and, as such, can be implemented via semiconductor(s) and/or transistors (e.g., using electronic integrated circuit (IC) components), and so forth. The controller 150 may be integrated directly into the robotic device 102 or be a separate component from the robotic device 102.

The controller 150 includes and executes control programming configured to cause the robotic device 102 to perform operations upon the workpiece according to a program of instructions. The operations that the controller executes are based upon the first precise, predetermined distance X1 and the second, precise predetermined distance Z1 of the rotary table assembly 100. In example embodiments, the robotic device 102 is in communication with the gearbox 130 and/or the motor 134, and can control rotation of the first table 110 or the second table 210 when the robotic device is connected to the first support surface 122 or the second support surface 222 respectively. For example, the controller 150 can include computer vision functionality for performing operations on items on the table based upon identifications made by the computer vision system.

In other embodiments, one of several robotic devices 202 may replace the robotic device 102 in the control and operation of the first rotary table assembly 100 and/or the at least second rotary table assembly 200. The robotic devices are configured to be interchangeable without calibration or recalibration.

The memory 154 is an example of tangible, computer-readable storage medium that provides storage functionality to store various data associated with operation of the memory 154 can store data, such as a program of instructions for operating the robotic device 102 (including its components), and so forth. It should be noted that while a single memory 154 is described, a wide variety of types and combinations of memory (e.g., tangible, non-transitory memory) can be employed. The memory 154 can be integral with the processor 152, can comprise stand-alone memory, or can be a combination of both.

The memory 154 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the robotic device 102 and/or the memory 154 can include removable integrated circuit card (ICC) memory, such as memory provided by a subscriber identity module (SIM) card, a universal subscriber identity module (USIM) card, a universal integrated circuit card (UICC), and so on.

The communications interface 156 is operatively configured to communicate with components of the robotic device 102. For example, the communications interface 156 can be configured to transmit data for storage in the robotic device 102, retrieve data from storage in the robotic device 102, and so forth. The communications interface 156 is also communicatively coupled with the processor 152 to facilitate data transfer between components of the robotic device 102 and the processor 152 (e.g., for communicating inputs to the processor 152 received from a device communicatively coupled with the controller 150). It should be noted that while the communications interface 156 is described as a component of a controller 150, one or more components of the communications interface 156 can be implemented as external components communicatively coupled to the dispenser system 100 via a wired and/or wireless connection. The dispenser system 100 can also comprise and/or connect to one or more input/output (I/O) devices (e.g., via the communications interface 156), including, but not necessarily limited to: a display, a mouse, a touchpad, a keyboard, and so on.

The communications interface 156 and/or the processor 152 can be configured to communicate with a variety of different networks, including, but not necessarily limited to: a wide-area cellular telephone network, such as a 3G cellular network, a 4G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to limit the present disclosure. Further, the communications interface 156 can be configured to communicate with a single network or multiple networks across different access points.

Generally, any of the functions described herein can be implemented using hardware (e.g., fixed logic circuitry such as integrated circuits), software, firmware, manual processing, or a combination thereof. Thus, the blocks discussed in the above disclosure generally represent hardware (e.g., fixed logic circuitry such as integrated circuits), software, firmware, or a combination thereof. In the instance of a hardware configuration, the various blocks discussed in the above disclosure may be implemented as integrated circuits along with other functionality. Such integrated circuits may include all of the functions of a given block, system, or circuit, or a portion of the functions of the block, system, or circuit. Further, elements of the blocks, systems, or circuits may be implemented across multiple integrated circuits. Such integrated circuits may comprise various integrated circuits, including, but not necessarily limited to: a monolithic integrated circuit, a flip chip integrated circuit, a multichip module integrated circuit, and/or a mixed signal integrated circuit. In the instance of a software implementation, the various blocks discussed in the above disclosure represent executable instructions (e.g., program code) that perform specified tasks when executed on a processor. These executable instructions can be stored in one or more tangible computer readable media. In some such instances, the entire system, block, or circuit may be implemented using its software or firmware equivalent. In other instances, one part of a given system, block, or circuit may be implemented in software or firmware, while other parts are implemented in hardware.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

While the subject matter has been illustrated and described in detail in the drawings and foregoing description, the same is to be considered as illustrative and not restrictive in character, it being understood that only the preferred embodiments have been shown and described and that all changes and modifications that come within the spirit of the subject matters are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the subject matter, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. An interchangeable robotic table system comprising:
a first rotary table assembly for rotatably supporting a workpiece, the first rotary table assembly including
a first table having a first table top surface positioned in a first plane, the first table having a first axis of rotation,
a first support frame for supporting the first table, the first support frame having
a first support surface spaced apart from the first axis of rotation of the first table at a first precise, predetermined distance, the first support surface positioned in a second plane at least substantially parallel to the first plane and spaced apart from the first plane at a second precise, predetermined distance,
a first support leg positioned beneath the first support surface,
a first plurality of support legs extending at least substantially radially with respect to the first axis of rotation of the first table for supporting the first table in cooperation with the first support leg,
a first longitudinal chassis connecting the first support surface, the first support leg, and the first plurality of support legs together, and
a first gearbox mount defined by the first longitudinal chassis, and
a first gearbox supported by the first gearbox mount and connected to the first table for precisely rotating the first table;
a second rotary table assembly for rotatably supporting a workpiece, the second rotary table assembly including
a second table having a second table top surface positioned in a third plane, the second table having a second axis of rotation,
a second support frame for supporting the second table, the second support frame having
a second support surface spaced apart from the second axis of rotation of the second table at the first precise, predetermined distance, the second support surface positioned in a fourth plane at least substantially parallel to the third plane and spaced apart from the third plane at the second precise, predetermined distance,
a second support leg positioned beneath the second support surface,
a second plurality of support legs extending at least substantially radially with respect to the second axis of rotation of the second table for supporting the second table in cooperation with the second support leg,
a second longitudinal chassis connecting the second support surface, the second support leg, and the second plurality of support legs together, and
a second gearbox mount defined by the second longitudinal chassis, and
a second gearbox supported by the second gearbox mount and connected to the second table for precisely rotating the second table; and
a robotic device interchangeably couplable with the first rotary table assembly and the second rotary table assembly at the first support surface and the second support surface, respectively, the robotic device having control programming configured to cause the robotic device to perform operations upon a workpiece according to a program of instructions, the operations based upon the first precise, predetermined distance and the second, precise predetermined distance, the robotic device controlling rotation of the first table or the second table as part of the operations.

2. The interchangeable robotic table system as recited in claim 1, wherein at least one of the first table or the second table comprises:
a center piece having exterior sides;
a plurality of support arms configured to fixedly connect to the center piece; and
a plurality of table top segments configured to be supported by the plurality of support arms, the plurality of table top segments having interior sides configured to interlock with one another and with the center piece, at least one table top segment of the plurality of table top segments and the center piece together defining a hole pattern, where interior sides of the at least one table top segment and exterior sides of the center piece extend generally diagonally within the hole pattern at right angles to one another to provide at least a minimum distance between the interior sides and the exterior sides and each hole of the hole pattern.

3. The interchangeable robotic table system as recited in claim 2, wherein the hole pattern is spaced to cause alignment of the plurality of support arms when the plurality of support arms is connected to the plurality of table top segments.

4. The modular table as recited in claim 2, wherein each one of the plurality of table top segments is interchangeable with every other one of the plurality of table top segments.

5. The modular table as recited in claim 2, wherein the center piece and the plurality of table top segments form a generally circular table top surface when interlocked together.

6. The modular table as recited in claim 2, wherein the plurality of support arms is configured to self-align with the plurality of table top segments when the plurality of table top segments is connected to the plurality of support arms.

7. The modular table as recited in claim 1, wherein at least one of the first longitudinal chassis or the second longitudinal chassis comprises at least one extension plate for extending the first longitudinal chassis or the second longitudinal chassis.

8. A rotary table assembly for rotatably supporting a workpiece, the rotary table assembly comprising:
a table having a table top surface positioned in a first plane, the table having an axis of rotation;
a support frame for supporting the table, the support frame having
a support surface spaced apart from the axis of rotation of the table at a first precise, predetermined distance, the support surface positioned in a second plane at least substantially parallel to the first plane and spaced apart from the first plane at a second precise, predetermined distance,
a support leg positioned beneath the support surface,
a plurality of support legs extending at least substantially radially with respect to the axis of rotation of the table for supporting the table in cooperation with the support leg,
a longitudinal chassis connecting the support surface, the support leg, and the plurality of support legs together, and
a gearbox mount defined by the longitudinal chassis; and
a gearbox supported by the gearbox mount and connected to the table for precisely rotating the table.

9. The rotary table system as recited in claim 8, wherein the table comprises:
a center piece having exterior sides;
a plurality of support arms configured to fixedly connect to the center piece; and
a plurality of table top segments configured to be supported by the plurality of support arms, the plurality of table top segments having interior sides configured to interlock with one another and with the center piece, at least one table top segment of the plurality of table top segments and the center piece together defining a hole pattern, where interior sides of the at least one table top segment and exterior sides of the center piece extend generally diagonally within the hole pattern at right angles to one another to provide at least a minimum distance between the interior sides and the exterior sides and each hole of the hole pattern.

10. The rotary table system as recited in claim 9, wherein the hole pattern is spaced to cause alignment of the plurality of support arms when the plurality of support arms is connected to the plurality of table top segments.

11. The rotary table system as recited in claim 9, wherein each one of the plurality of table top segments is interchangeable with every other one of the plurality of table top segments.

12. The rotary table system as recited in claim 9, wherein the center piece and the plurality of table top segments form a generally circular table top surface when interlocked together.

13. The rotary table system as recited in claim 9, wherein the plurality of support arms is configured to self-align with the plurality of table top segments when the plurality of table top segments is connected to the plurality of support arms.

14. The rotary table system as recited in claim 8, wherein the longitudinal chassis comprises at least one extension plate for extending the longitudinal chassis.

15. A robotic table system comprising:
a rotary table assembly for rotatably supporting a workpiece, the rotary table assembly including
a table having a table top surface positioned in a first plane, the table having an axis of rotation,
a support frame for supporting the table, the support frame having
a support surface spaced apart from the axis of rotation of the table at a first precise, predetermined distance, the support surface positioned in a second plane at least substantially parallel to the first plane and spaced apart from the first plane at a second precise, predetermined distance,
a support leg positioned beneath the support surface,
a plurality of support legs extending at least substantially radially with respect to the axis of rotation of the table for supporting the table in cooperation with the support leg,
a longitudinal chassis connecting the support surface, the support leg, and the plurality of support legs together, and
a gearbox mount defined by the longitudinal chassis, and
a gearbox supported by the gearbox mount and connected to the table for precisely rotating the table; and
a robotic device couplable with the rotary table assembly at the support surface, the robotic device having control programming configured to cause the robotic device to perform operations upon a workpiece according to a program of instructions, the operations based upon the first precise, predetermined distance and the second, precise predetermined distance, the robotic device controlling rotation of the table as part of the operations.

16. The robotic table system as recited in claim 15, wherein the table comprises:
a center piece having exterior sides;
a plurality of support arms configured to fixedly connect to the center piece; and
a plurality of table top segments configured to be supported by the plurality of support arms, the plurality of table top segments having interior sides configured to interlock with one another and with the center piece, at least one table top segment of the plurality of table top segments and the center piece together defining a hole pattern, where interior sides of the at least one table top segment and exterior sides of the center piece extend generally diagonally within the hole pattern at right angles to one another to provide at least a minimum distance between the interior sides and the exterior sides and each hole of the hole pattern.

17. The robotic table system as recited in claim 16, wherein the hole pattern is spaced to cause alignment of the plurality of support arms when the plurality of support arms is connected to the plurality of table top segments.

18. The robotic table system as recited in claim 16, wherein each one of the plurality of table top segments is interchangeable with every other one of the plurality of table top segments.

19. The robotic table system as recited in claim 16, wherein the center piece and the plurality of table top segments form a generally circular table top surface when interlocked together.

20. The robotic table system as recited in claim 16, wherein the plurality of support arms is configured to self-align with the plurality of table top segments when the plurality of table top segments is connected to the plurality of support arms.
